(19) United States
(12) Patent Application Publication
(10) Pub. No.: US 2003/0192371 A1
(43) Pub. Date: Oct. 16, 2003

(54) Combination tire gauge valve stem

(76) Inventor: William R. Cousineau, Sudbury (CA)

Correspondence Address: Mike M. Gauthier, 1264156 Ontario Incorporated, o/a Intel-Pro Design and Mfg., 959 Elisabella Street, Unit C, Sudbury, ON, P3A 5K1, CA

(21) Appl. No.: 10/119,007

(22) Filed: Apr. 10, 2002

(51) Int. Cl. G01M 17/02

(52) U.S. Cl. 73/146

(57) ABSTRACT

In an accessory device utilized to inflate and deflate conventional tubed or tubeless tire, and giving the user an indication of the amount of air pressure within the tire's chamber, the device of the present invention comprises; a flexible rim-attaching portion having a larger lower body portion than the rim perforation of a conventional tire and a central neck portion having an outside diameter equal or lesser than said rim perforation, a rigid central gauge portion having a transparent molded tube-like form imprinted with markings identifying the location of a moveable luminescent spring loaded rubber indicator adapted to travel longitudinally within said gauge portion, and an upper valve portion having a centered stem portion in direct communication with a valve seal where perforations in the valve seal are in misalignment with perforations in the valve seat. Therefore, when a tire is under pressure, the inner air pressure exerts positive pressure against the under side of the spring loaded lower valve seal which in turn, displaces the location of said seal, indicating the tire's air pressure.

### FIELD OF THE INVENTION

The present invention relates to an accessory device utilized to inflate and deflate conventional tubed or tubeless tires while giving the user an indication of the amount of air pressure within the tire's chamber. The accessory device of the present invention comprises; a flexible rim-attaching portion having a larger lower body portion than the rim perforation of a conventional tire and a central neck portion having an outside diameter equal or lesser than said rim perforation, a rigid central gauge portion having a transparent molded tube-like form imprinted with markings identifying the location of a moveable luminescent spring loaded rubber indicator adapted to travel longitudinally within said gauge portion, and an upper valve portion having a centered stem portion in direct communication with a valve seal where perforations in the valve seal are in misalignment with perforations in the valve seat. Therefore, when a tire is under pressure, the inner air pressure exerts positive pressure against the under side of the spring loaded lower valve seal which in turn, displaces the location of said seal, indicating the tire's air pressure.

### BACKGROUND OF THE INVENTION

For many years, inventors have attempted to adapt tire valve stems with an air pressure gauge. However, some of these inventions either did not work or failed to have the flexibility necessary for the abuse taken by valve stems. It is common for drivers to utilize an accessory tire gauge which requires the removal of the valve stem cover, thereby soiling the driver's fingers in doing so.

Accordingly, it is desirable for drivers to be aware of their vehicle tires' air pressure at a glance, as it is desirable to have this function available in a manner that boasts safety.

Furthermore, owners of these devices desire that the device be permanently installed from within the tire rim to the outside rather than from the outside so as to prevent the theft of these devices.

The applicant is aware of several attempts in prior art to provide means of combining a valve stem and a tire gauge. For example, reference may be had to U.S. Pat. No. 1,423,447 of Noe, issued Jul. 18, 1922, which describes a rigid valve stem with a pressure gauge primarily designed to adapt to bicycles. However, this device fails to provide the required flexibility to resist breakage from the day to day abuse imposed onto the device.

Another example of prior art may be had in referring to U.S. Pat. No. 3,230,968 of Struby, issued Jan. 25, 1966, which depicts a permanently installed valve having a color code indicator. However, this valve is very short, malting it difficult to view a reading. Additionally, its rigidity may pose a problem in abusive conditions. Furthermore, the telescopic portion is subjected to the elements of dirt and granular material which would therefore render the gauge inaccurate.

Another example of prior art may be had in referring to U.S. Pat. No. 3,906,988 of Mottram, issued Sep. 23, 1975, which illustrates a rigid valve and gauge combination. Again, this valve is rigid and fails to have the ability to flex if stricken.

While many prior art inventions have succeeded in providing vehicle operators with a combination air pressure gauge and valve stem, none have succeeded in offering flexibility with accuracy and durability in such valve stems.

### SUMMARY OF THE INVENTION

It is thus the object of the present invention to provide vehicle operators with a combination air pressure gauge and valve stem having flexibility, accuracy and durability all in one affordable unit.

In one aspect of the invention, there is provided a daylight chargeable luminescent gauge indicator which illuminates in darkness.

In another aspect of the invention, the valve/gauge combination may be calibrated to suit various ranges in pressure by altering the back-load spring and visual markings.

In another aspect of the invention, the valve stem of the present invention may be adapted to form an integral part of a tubed tire by providing a flanged rubber extension to the base so as to allow fixed adhesion to a perforation in a tire tube.

Accordingly, the accessory device of the present invention allows not only the gauging of pneumatic air pressure, but also provide structural flexibility of the unit while having a luminescent gauge indicator.

The utility of this accessory device includes but is not limited to conventional pneumatic tires.

### BRIEF DESCRIPTION OF THE DRAWINGS

These and other advantages of the invention will become apparent upon reading the following detailed description and upon referring to the drawings in which:

FIG.1 is a perspective view from above of the combination tire gauge valve stem of the present invention as installed on a tire rim.

FIG. 2 is a cross section view from FIG. 5 of the upper valve portion of the present invention.

FIG. 3 is a front elevation view of the combination tire gauge valve stem of the present invention.

FIG. 4 is a cross section view from FIG. 6 of the rim-attaching portion of the present invention.

FIG. 5 is a front cross section view of the combination tire gauge valve stem of the present invention while in an inert position.

FIG. 6 is a front cross section view of the combination tire gauge valve stem of the present invention as shown being inflated.

FIG. 7 is a front cross section view of the combination tire gauge valve stem of the present invention while under pressure.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

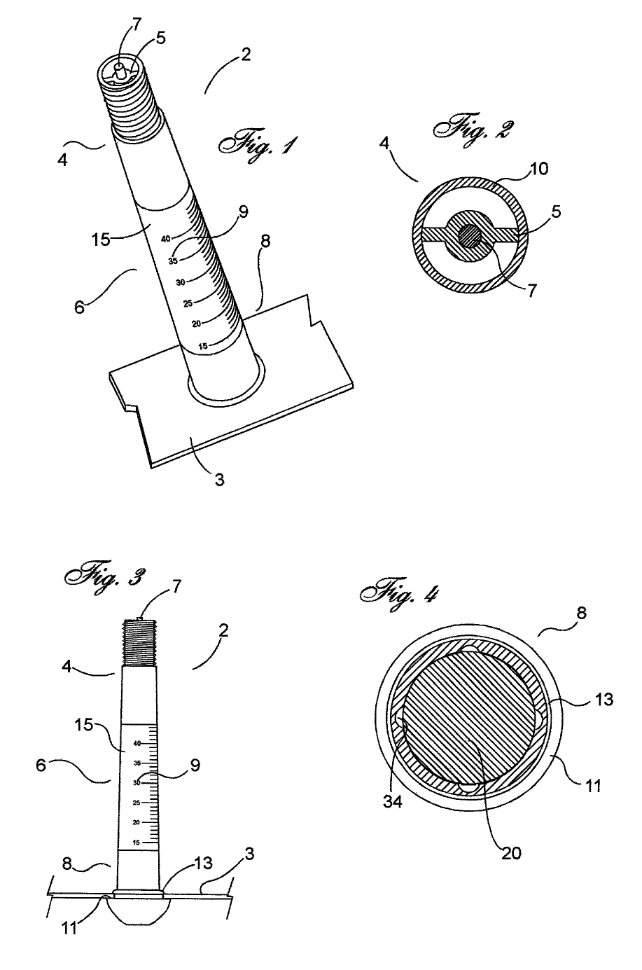

Turning to FIG. 1, which illustrates a perspective view from above of the combination tire gauge valve stem 2 of the present invention as installed on a tire rim 3 having an upper valve portion 4, a central gauge portion 6 and a lower rim-attaching portion 8. The central gauge portion 6 is marked with a numeric scale 9 related to the calibration of the combination tire gauge valve stem 2 of the present invention.

Now turning to FIG. 2, illustrating a cross section view the upper valve portion 4 of the combination tire gauge valve stem 2 of the present invention depicting the form of the valve pin 7 centering guide 5 whereby there is provided a through passage of air beyond said centering guide 5.

Turning to FIG. 3, which illustrates a front elevation view of the combination tire gauge valve stem 2. The combination tire gauge valve stem 2 comprises; an upper valve portion 4, a central gauge portion 6 and a lower rim attaching portion 8. The central gauge portion 6 is marked with a numeric scale 9 related to the calibration of the combination tire gauge valve stem 2 of the present invention.

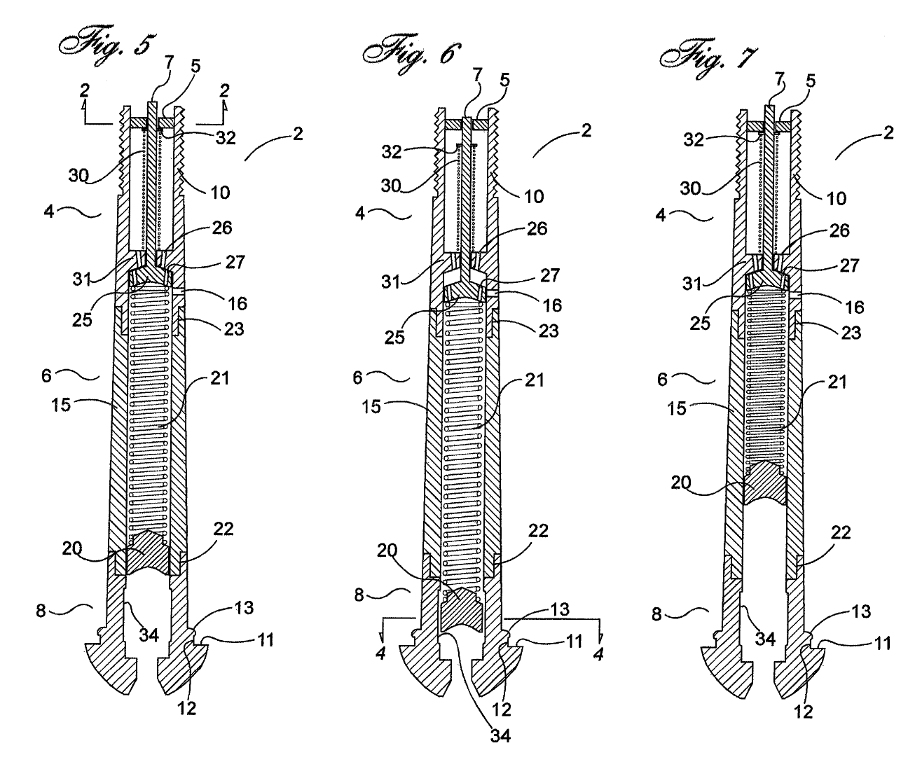

Turning now to FIG. 4, depicting a cross section view of the lower rim attaching portion 8 of the combination tire gauge valve stem 2 of the present invention illustrating material removed from the inner surface of the lower rim attaching portion 8 whereby the gauge indicator 20 loses its seal ability while in this position, allowing air passage beyond gauge indicator 20.

In reference now to FIG. 5, depicting a cross section view of the combination tire gauge valve stem 2 of the present invention illustrating its position in an inert state. The combination tire gauge valve stem 2 is installed by inserting said stem 2 through the perforation provided in a conventional tire rim 3 ensuring that the rim sealing portion 11 is in contact with the inside of the rim 3. Beyond the lower rim-attaching portion 8 is provided a central gauge portion 6 comprising: a transparent cylindrical sleeve 15 adapted to be fixedly bonded to the lower rim attaching portion 8 by means of overlapped sections 22 permanently bonded together; a rubber piston-like gauge indicator 20 having an outside diameter equal to the inside diameter 24 of the transparent cylindrical sleeve 15 so as to form a longitudinally impermeable seal between gauge indicator 20 and the transparent cylindrical sleeve 15, and a coil spring 21 located within the inner area of the transparent cylindrical sleeve 15 and frictionally attached to the gauge indicator 20; and an upper valve portion 4 having a metallic body adapted with a threaded upper portion 10 for securing of a conventional dust cap, a valve seat 31 having a plurality of arrayed perforations 26 allowing the through passage of air, a valve stem 7 adapted to pass through a centered perforation of the valve seat 31, a valve seal 25 integrally attached to a valve pin 7 having a plurality of arrayed perforations 27 in misalignment with the perforations of the valve seat 31, a flange stop 32 integral with the valve stem 7 against which a coil spring 30 is placed between said flange stop 32 and valve seat 31 exerting an upward pressure of the valve seal 25 against the valve seat 31 thereby creating a positive impermeable seal. The lower portion of the upper valve portion 4 is fixedly bonded to the upper portion of the transparent cylindrical sleeve 15 by means of overlapped sections 23 permanently bonded together. Within the upper valve portion 4 of the device 2 of the present invention, there is provided a relief vent 16 adapted to relieve the positive pressure created by the upward movement and negative pressure created by the downward movement of the gauge indicator 20.

FIG. 6, depicting a cross section view of the combination tire gauge valve stem 2 of the present invention illustrating its position during inflation. During inflation, the valve stem 7 is depressed downwardly which in turn separates the valve seal 25 from the valve seat 31 allowing air to pass through both arrays of perforations 26 and 27 of the valve seat 31 and valve seal 25. The valve seal 25 blocks the passage of air to the relief vent 16 as the valve stem 7 is depressed. This, in effect, exerts positive pressure on the top of the gauge indicator 20, forcing said gauge indicator 20 toward and within the inner surface 34 of the lower rim attaching portion 8 which allows through flow of the air to the tire's chamber.

Turning now to FIG. 7, an illustration of the combination tire gauge valve stem 2 of the present invention illustrating its position under pressure. In this state, once inflated, air pressure is built up within the tire's chamber and since the gauge indicator's 20 lower surface is in communication with said chamber's air, a force directly related to the amount of pressure within the tire's chamber is applied to the lower surface of the gauge indicator 20 thereby displacing said indicator 20 upwardly against the coil spring 21 within the transparent cylindrical sleeve 15 therefore placing the gauge indicator 20 in the corresponding position in the sleeve 15 corresponding to the markings 9 on the sleeve 15. In daylight, the gauge indicator 20 would be visible through the transparent cylindrical sleeve 15 thus displaying the corresponding numerical reference relative to the tire's air pressure. In darkness, the luminescent properties of the gauge indicator 20 would make the numerical markings on the cylindrical sleeve 15 clearly visible. The greater the tire's air pressure, the further upwardly the gauge indicator 20 would be displaced.

The embodiments of the invention in which an exclusive property or privilege is claimed are defined as follows: /What I claim as my invention:

1. A combination tire gauge valve stem comprising:
a. a tire valve stem adapted to allow the controlled intake and dispensing of air within a conventional tire's chamber,
b. a tire valve stem also adapted to gauge at a glance, the air pressure within the inner surface of a conventional tire's chamber,

2. The combination tire gauge valve stem of claim 1 wherein said gauge means are attained by a spring loaded piston-like gauge indicator counteracting the tire's air pressure visible through a transparent central portion of said stem.

3. The combination tire gauge valve stem of claim 2 wherein the piston-like gauge indicator is molded with a semi-flexible luminescent material having daylight recharging properties.

4. The combination tire gauge valve stem of claim 1 wherein the generally central region of the stem is transparent and is adapted with numeric markings in calibration with the tire's pressure range.

5. The combination tire gauge valve stem of claim 1 wherein the lower rim attaching portion is formed so that the inside diameter of the upper portion of said rim attaching portion is adapted with lengthwise indentations so as to allow the passage of air around the gauge indicator for inflation of tire chamber.

6. The combination tire gauge valve stem of claim 1 wherein the upper valve portion consists of a valve seat and a valve seal each having a plurality of perforations therethrough in misalignment whereby when valve seal is seated onto valve seat, the flow of air is restricted and when the valve seal is separated from valve seat, the flow of air is made possible.

7. The combination tire gauge valve stem of claim 1 wherein the lower rim-attaching portion is adapted with a plurality of lengthwise indentations within the inner surface of said rim-attaching portion so as to allow through-passage of air when gauge indicator is displaced to that area.
